(19) United States
(12) Patent Application Publication
(10) Pub. No.: US 2014/0356583 A1
(43) Pub. Date: Dec. 4, 2014

(54) COMPOSITE PLATE

(71) Applicant: GM GLOBAL TECHNOLOGY OPERATIONS LLC, Detroit, MI (US)

(72) Inventors: Ronald Sanders, Daxweiler (DE); Hartmut Baumgart, Bischofsheim (DE)

(73) Assignee: GM GLOBAL TECHNOLOGY OPERATIONS LLC, Detroit, MI (US)

(21) Appl. No.: 14/270,173

(22) Filed: May 5, 2014

(30) Foreign Application Priority Data
May 4, 2013 (DE) 102013007700.1

(51) Int. Cl. B62D 29/00; F16H 57/032

(52) U.S. Cl. CPC B62D 29/007; B62D 29/008; F16H 57/032
USPC 428/172

(57) ABSTRACT

A composite plate is disclosed which includes a first metal sheet, a second metal sheet and a connecting layer arranged between the metal sheets. The first metal sheet consists of a first metal material and the second metal sheet of a second metal material that is different from the first metal material. The second metal sheet, between regions which are closely adjacent to the first metal sheet and fastened to the first metal sheet through the connecting layer includes regions which are each spaced further from the first metal sheet.

### CROSS REFERENCE TO RELATED APPLICATION

This application claims priority to German Patent Application No. 102013007700.1 filed May 4, 2013, which is incorporated herein by reference in its entirety.

### TECHNICAL FIELD

The present disclosure relates to a composite plate, which is suitable in particular for use in motor vehicle applications.

### BACKGROUND

A conventional composite plate is known from DE 19839931 A1 to include thin first and second metal sheets as well as a connecting layer in the form of a wire or expanded metal grid. First and second metal sheets are held together by a foamed adhesive, which also fills out hollow spaces of the grid.

In order to reduce the weight of the motor vehicles and thereby reduce their fuel consumption, efforts are made to produce motor vehicle bodies at least partially from light metals. In the process, galvanic elements can develop between the light metal and components which have to consist of steel for reasons of stability, which galvanic elements can result in contact corrosion and therefore have to be avoided. A composite plate, in which a first surface consists of a first metal material and a second surface of a second metal material and in which these metal materials are reliably galvanically separated from one another, could facilitate the use of different metals in a vehicle in that on the first surface of such a composite plate parts of the vehicle are fastened which consist of the first metal material or materials which are electrochemically compatible with this first metal material, whereas parts which consist of the second metal material or a material that is electrochemically compatible therewith, are fastened to the second surface.

However, the abovementioned conventional composite plate is unsuitable for when different metal materials which are not electrochemically compatible with one another are employed with the first and second metal sheet such that a galvanic contact between first and second metal sheet would exist resulting from a deformation of the composite plate by way of the grids located in between, which would result in contact corrosion.

The thermal expansion coefficients of the various metal materials which are generally different can result in shear loads of the adhesive layer in the case of the conventional composite plate. If the adhesive is strong enough in order to rigidly join the metal sheets, the composite plate has a tendency towards warpage during temperature fluctuations. When by contrast the adhesive can deform under the shearing load fatigue of the adhesive can occur in the long term so that the metal sheets of the composite plate become detached from one another.

Accordingly, there is a need in the art to create a composite plate in which the metal sheets are durably held together tightly and which are not susceptible to warpage during temperature fluctuations even when the metal sheets consist of metal materials having difference thermal expansion coefficients.

### SUMMARY

In accordance with the present disclosure a composite plate is provided with a first metal sheet having at least localized flat areas, a second metal sheet having localized irregularities rending it not flat in those areas, and a connecting layer arranged between the metal sheets, in which the first metal sheet consists of a first metal material and the second metal sheet of a metal material that is different from the first metal material and the second metal sheet between regions which are closely adjacent to the first metal sheet and fastened through the connecting layer to the first metal sheet. The irregularities formed in the second sheet provide regions which are further spaced from the first metal sheet.

The non-flatness of the second metal sheet allows the sheet to yield to forces which act in the surface direction of the composite plate, in particular thermal stresses, through local bending of its irregularities. Thus, the stresses which occur between the two metal sheets can be kept within limits and the load of the connecting layer through thermal stresses is also low. For this reason there is neither the risk that the composite plate is warped during temperature fluctuations nor must material fatigue in the connecting layer be expected.

In order to exclude the risk of contact corrosion, the connecting layer should be galvanically insulating.

The regions of the second metal sheet which are spaced from the first metal sheet are preferentially formed as ribs extending between the adjacent regions. The adjacent regions can be glued to the first metal sheet over the full area through the connecting layer. By becoming wider or narrower, the ribs can yield to different rates of expansion of the first and of the second metal material during temperature fluctuations.

On the side of the second metal sheet facing the first metal sheet a depression may be located opposite the rib facing away from the first metal sheet. In order to facilitate yielding of the rib during thermal stresses, the depression may be at least partially free of the connecting layer. The rib can be part of a pattern that is periodically repeated over the surface of the second metal sheet. Such a pattern can be easily created through embossing with the help of rollers, between which the second metal sheet is passed through.

The pattern is preferentially two-dimensionally periodical in order to make possible yielding with respect to thermal stresses in each direction. A symmetry of the rib pattern facilitates the placing of the composite plate on a forming tool with recesses that are complementary to the ribs, for the higher the symmetry of the pattern the more numerous are the orientations in which the composite plate can be placed on the forming tool so that its ribs engage in the recesses of the forming tool.

For limiting the stresses it is practical furthermore when the adjacent regions of the second metal sheet are delimited by ribs all round. Such a limitation of the adjacent regions can be achieved in particular in that the pattern is a parallelogram patter, i.e. in that the ribs extend in two different directions over the face of the second metal sheet, crossing one another in the process. In order to achieve a high bending stiffness of the composite plate, a honeycomb pattern is preferred as pattern. With such a pattern, three ribs each meet at a point from different directions and there are no ribs which continuously extend over large distances on the second metal sheet.

Since the connecting layer does not have to offset a severe thermal warpage between the metal sheets it can be thinner than that of the conventional composite plate. In order to securely and permanently glue the metal sheets to one another, a connecting layer is preferred, which is thinner than the metal sheets themselves.

The metal of the second metal sheet preferentially has a lower strength than that of the first metal sheet. On the one hand, this facilitates the embossing of the irregularities but on the other hand also the deformation of the spaced regions or ribs which are required for offsetting different thermal expansion coefficients. In addition, the ribs themselves bring about a desirable stiffening of the second metal sheet.

In practice, the first metal sheet is preferably a steel sheet and the second metal sheet a light metal sheet, for example an aluminum or magnesium sheet.

A composite plate in accordance with the present disclosure is useful as a component of a motor vehicle. Such a component can in particular be a front wall or a transmission cover. In such applications, ribs on the second metal sheet may be exposed to facilitate discharging waste heat, for example from transmission oil of the transmission closed by the cover. The connecting layer can dampen vibrations of the two metal sheets, which is advantageous in particular in a front wall extending between engine compartment and passenger cell in order to keep the noise level in the passenger cell low.

### BRIEF DESCRIPTION OF THE DRAWINGS

The present disclosure will hereinafter be described in conjunction with the following drawing figures, wherein like numerals denote like elements, and:

FIG. 1 schematically illustrates the production of a composite plate according to the present disclosure;

FIG. 2 shows a view of the composite plate according to a first configuration of the present disclosure; and

FIG. 3 shows a piece of composite plate according to a second configuration of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

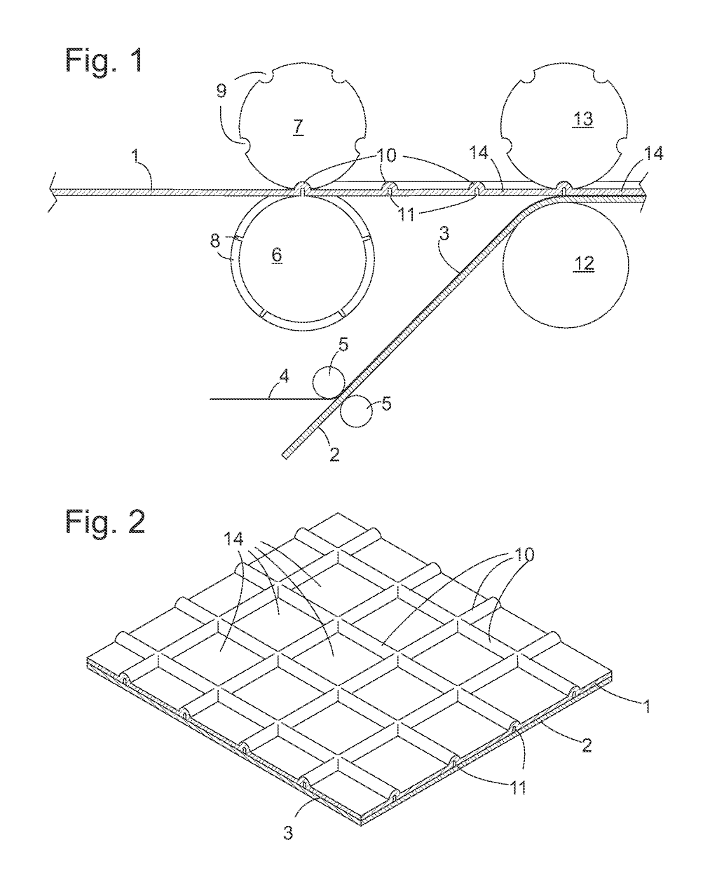

FIG. 1 schematically illustrates fabrication of a composite plate according to the present disclosure. Included in the composite plate are a light metal sheet 1 and a steel sheet 2, each of which are unwound from coils which are not shown in the figure. The light metal of the sheet 1 can in particular be an aluminum or magnesium alloy. Onto the steel sheet 2, a connecting layer 3 of an electrically insulating plastic is applied on one side. In FIG. 1, this takes place through laminating a film 4 onto the steel sheet 2 with the help of rollers 5, between which steel sheet 2 and film 4 can pass through and are pressed against one another. Alternatively, the connecting layer 3 could also be obtained by applying and spreading a pasty adhesive onto the steel sheet 2. The use of the film 4 has the advantage that the connecting layer 3 that is obtained is reliably free of holes, which if otherwise present could make possible a galvanic contact between the metal sheets 1, 2. The film 4 can be coated on both sides with an immediately active adhesive or with an adhesive that is activatable by heat.

The light metal sheet 1 passes through a pair of embossing rollers 6, 7, of which the roller 6 on its circumference is provided with elongated protrusions 8 and the other roller 7 with recesses 9 that are complementary to the protrusions 8. During the passage between the rollers 6, 7 a periodical pattern of ribs 10 projecting from the upper side of the light metal sheet 1 facing away from the steel sheet 2 and depressions 11 each located opposite these on the lower side facing the steel sheet 2.

On a last pair of rollers 12, 13, the metal sheets 1, 2 meet one another and are pressed against one another. At least one of the rollers 12, 13 can be heated if this is needed for activating the adhesive of the connecting layer 3. The width of the gap between the rollers 12, 13 is dimensioned so that the flat regions 14 of the light metal sheet 1 delimited by the ribs 10 or depressions 11 each come into close contact with the connecting layer 3. The connecting layer 3 in this case can be plastically deformed so that it enters the depressions 11. When the connecting layer 3 is durably plastically deformable it can be permitted that it fills out the depressions 11; preferably, however, the depressions 11 remain completely or at least partially free of the connecting layer 3.

FIG. 2 shows a piece of composite plate according to a first configuration of the present disclosure in a perspective view. The ribs 10 of the light metal sheet 1 cross one another at a right angle, and thus form a rectangular pattern each with rectangular flat regions 14 glued to the steel sheet 2 by the connecting layer 3. The light metal sheet 1 has a higher thermal expansion coefficient than the steel sheet 2. This results such that when the composite plate is heated, the flat regions 14 expand while the ribs 10 are upset at the same time so that the composite plate as a whole remains level. In a corresponding manner, the ribs 10 can be upset or widened when the composite plate is exposed to a bending load. The flat regions 14 in this case are square, i.e. pattern formed by the ribs 10 is quartic rotation-symmetrical.

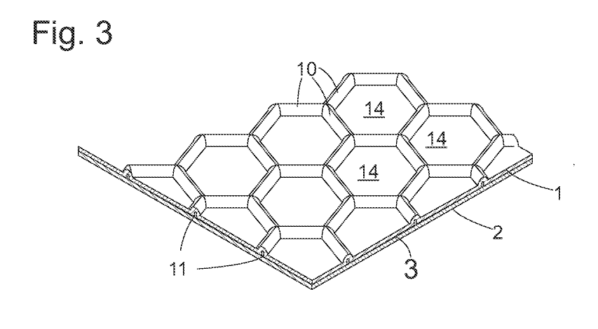

In the configuration of the composite plate shown in a perspective view in FIG. 3 the flat regions 14 are equilateral hexagons. Each rotation of one of these hexagons about itself by an angle of 60° transfers the pattern formed by the ribs 10 into itself, the pattern accordingly is six-fold rotation-symmetrical. Other than with the configuration of FIG. 2, there is no rib which continuously extends over the entire composite plate but only short ribs 10 each, which at the corners of the flat regions 14 abut other ribs 10 at an angle of 120°. There is therefore no direction in which the composite plate of FIG. 3 could be bent without the ribs 10 being exposed to shearing and tensile forces acting in their longitudinal direction. Through such forces, the ribs 10 can only be deformed with difficulty, which is why with the same material thickness of the metal sheets 1, 2 and the same cross-section of the ribs 10 as in the configuration of FIG. 2, an even higher bending stiffness can be achieved. The insensitivity to thermal stresses is just as high as with the configuration of FIG. 2 since exactly as with the latter, different expansion coefficients of light metal sheet 1 and steel sheet 2 merely lead to an upsetting or tensile loading in transverse direction of the ribs 10.

From the composite plates of FIG. 2 or 3, various motor vehicle components such as for example a front wall, a transmission cover or the like can be produced through cutting to size and forming Preferably, the forming is carried out through deep-drawing; in particular, the sheet 1 should be exposed to a hydrostatic pressure in the process in order to exclude damaging its ribs 10 through friction on a forming tool. Further processing of the composite plate according to the present disclosure through roll forming or press forming is likewise possible, during which it must be observed however that at least one of the forming tools used in the process has a pattern of depressions that is complementary to the pattern of the ribs, which receives the ribs during the deformation of the composite plate, in this way preventing that these are pressed flat during the forming between the tools or for example during the forming of a sharp bend crossing a rib, tip over.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A composite plate well-suited for use in motor vehicle applications comprising:
a first sheet of a first metal material;
a second sheet of a second metal material which is different than the first metal material, the second sheet having planar regions adjacent to the first sheet and a plurality of relieved regions which are adjacent the planar regions and extend away from the first sheet; and
a connecting layer arranged between the first and second sheets for securing the first sheet to the planar regions of the second sheet.

17. The composite plate according to claim 16, wherein the connecting layer comprises a galvanically insulating layer between the first and second sheets.

18. The composite plate according to claim 16, wherein the plurality of relieved regions comprise a rib structure extending away from the first sheet.

19. The composite plate according to claim 18 wherein the rib structure defines a depression on the side of the second sheet facing the first sheet.

20. The composite plate according to claim 19, wherein the depression is at least partially free of the connecting layer.

21. The composite plate according to claim 18 wherein the rib structure comprise a pattern of rib elements which is periodically repeated over the face of the second sheet.

22. The composite plate according to claim 21 wherein the pattern comprises a two-dimensional periodically repeating pattern.

23. The composite plate according to claim 18 wherein the planar regions adjacent to the first sheet are delimited by the rib structure all round.

24. The composite plate according to claim 22, wherein the pattern comprise a parallelogram pattern.

25. The composite plate according to claim 22, wherein the pattern comprises a honeycomb pattern.

26. The composite plate according to claim 16, wherein the connecting layer is thinner than the first and second sheets.

27. The composite plate according to claim 16, wherein the second metal material has a lower strength than a strength of the first metal material.

28. The composite plate according to claim 16, wherein the first metal material is steel and the second metal material is a light metal material.

29. The composite plate according to claim 28, wherein the second metal material is selected from the group consisting of aluminum, aluminum alloy, magnesium or magnesium alloy.

30. A component of a motor vehicle, in which it is produced from a composite plate according to claim 16.

31. The component according to claim 30, wherein the component is selected from the group consisting of a transmission cover and a front wall portion.
